(19) United States
(12) Patent Application Publication
(10) Pub. No.: US 2025/0260981 A1
(43) Pub. Date: Aug. 14, 2025

(54) A Computer Implemented Method and System of Issuing Electronic Certificates

(71) Applicant: Kwok Seng CHEAH, Hong Kong (CN)

(72) Inventor: Kwok Seng CHEAH, Hong Kong (CN)

(21) Appl. No.: 18/703,739

(22) PCT Filed: Apr. 11, 2024
(86) PCT No.: PCT/CN2024/087299

§ 371 Date: May 21, 2024

(30) Foreign Application Priority Data
Jul. 13, 2023 (HK) 32023075953.4

(51) Int. Cl. H04W 12/069

(52) U.S. Cl. CPC H04W 12/069

(57) ABSTRACT

The invention relates to a computer implemented method and system of issuing electronic certificates. The method comprises the steps of receiving a request from an applicant for an electronic certificate, the request comprising certificate information and applicant identification; verifying the applicant identification; identifying one or more relevant certificate issuing units from a plurality of certificate issuing units according to the certificate information; and upon verifying the certificate information by the one or more relevant certificate issuing units, issuing the electronic certificate in accordance with the request.

### FIELD OF THE INVENTION

The invention relates to the field of electronic or digital certificates, and particularly, but not exclusively, toa method and a system of issuing and managing electronic certificates.

### BACKGROUND OF THE INVENTION

Certificates have been utilized to establish the qualification or credential of individuals, such as academic and professional certificates, and to verify the authenticity and origin of products, such as anti-counterfeiting certificates for commodities and luxury goods. Additionally, certification marks such as organic labels or marks for agricultural products, serve as proof of quality and compliance with specific standards or regulations. Typically, these certificates are presented in the form of paper or marked directly on products to serve as evidence of their identity.

However, traditional methods of issuing certificates suffer from inherent limitations. For example, paper-based certificates are vulnerable to forgery and misuse, which compromise their credibility and reliability. While electronic or digital certificates offer advantages such as accessibility and enhanced security, existing certificate providers often deliver their certificates in different formats, making seamless storage and utilization of electronic certificates challenging. Consequently, the widespread use and effectiveness of electronic certificates are often hindered.

There is a need for a solution that addresses these challenges and improves the issuance and/or management process of electronic certificates.

### OBJECTS OF THE INVENTION

An object of the invention is to mitigate or obviate to some degree one or more problems associated with known systems and methods of issuing and/or managing certificates.

Another object of the invention is to provide an improved system and method of issuing and/or managing electronic certificates.

The above object is met by the combination of features of the main claims; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a computer implemented method of issuing electronic certificates. The method comprising the steps of receiving a request from an applicant for an electronic certificate, with the request comprising certificate information and applicant identification; verifying the applicant identification; identifying one or more relevant certificate issuing units from a plurality of certificate issuing units according to the certificate information; and upon verifying the certificate information by the one or more relevant certificate issuing units, issuing the electronic certificate in accordance with the request.

Preferably, the step of receiving a request from an applicant comprises receiving information communicated wirelessly from an applicant's device.

Preferably, the step of receiving a request from an applicant comprises scanning of a two-dimensional code by an applicant's device and/or receiving via short range wireless communication by the applicant's device.

Preferably, the method further comprises the step of transmitting the issued electronic certificate to the applicant's device.

Preferably, the step of verifying the certificate information by the one or more relevant certificate issuing units comprises matching data relevant to the certificate information from one or more databases.

Preferably, the method further comprises the step of storing the issued electronic certificate in associate with the applicant, with the stored electronic certificate being accessible by one or more of an applicant's device and/or an issuer's device.

Preferably, the plurality of certificate issuing units are independently operable by respective certificate issuers via corresponding issuers' devices.

Preferably, the method further comprises the step of customizing the electronic certificates by the respective certificate issuers.

Preferably, the method further comprises the step of issuing reward points to the applicant, wherein the reward points are provided in the form of one or more credits, loyalty points, cash coupons, vouchers and/or user ratings, tiers, or rankings.

Preferably, the issued electronic certificate is stored under classification by type of the issued certificate, with the classification being displayable at the applicant's device.

Preferably, the issued electronic certificate is stored under classification by the certificate information and/or the applicant identification, with the classification being displayable at the issuer's device.

Preferably, the method further comprises the step of sharing the issued electronic certificate to one or more designated recipients and/or social media networks.

Preferably, the step of issuing an electronic certificate comprises generating a two-dimensional code in associate with the certificate.

In a second main aspect, the invention provides a computer implemented system implementing the method of the first main aspect for issuing electronic certificates. The system
comprises a certificate requesting module and a certificate issuing module. The certificate issuing module comprises a plurality of certificate issuing units. The certificate requesting module comprises: a receiving module for receiving a request from an applicant for issuing an electronic certificate, the request comprising certificate information and applicant identification;
a verification module for verifying the applicant identification; an identification module for identifying one or more relevant certificate issuing units from the plurality of certificate issuing units of the certificate issuing module according to the certificate information;

Preferably, the certificate requesting module is adapted to receive the request for issuing an electronic certificate from a user device via wireless communication.

Preferably, the certificate requesting module is adapted to receive the request for issuing an electronic certificate via scanning of a two-dimensional code and/or via short-range wireless communication.

Preferably, the plurality of certificate issuing units of the certificate issuing module are independently operable by respective certificate issuers via corresponding issuers' devices.

Preferably, the system further comprises a storage module for storing the issued electronic certificate in associate with the applicant.

Preferably, the system further comprises a reward module for issuing reward points to the applicants, wherein the reward points are provided in the form of one or more credits, loyalty points, cash coupons, vouchers and/or user ratings, tiers, or rankings.

In a third main aspect, the invention provides a non-transitory computer readable medium storing machine-readable instructions which, when implemented on a processor, implements the method of the first main aspect.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a block schematic diagram showing a computer implemented system for issuing electronic certificates according to an embodiment of the present invention; and

FIG. 2 is a flow diagram showing the method steps implemented by the embodied computer system of FIG. 1.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the figures, may be implemented in various forms of hardware, software or combinations thereof. These elements may be implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e. any elements developed that perform the same function, regardless of structure.

Thus, for example, it will be appreciated by those skilled in the art that the block diagram presented herein represent conceptual views of system embodying the principles of the invention.

The functions of the various elements or components shown in the figures may be provided through the use of dedicated software, hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element or component expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

The present invention generally relates to a computer implemented method and system for issuing and managing electronic certificates. Particularly, the invention provides a computer-implemented platform for use by both the certificate applicants and the certificate issuers, i.e. for the certificate applicant to request issuance of electronic certificates from different certificate issuing bodies, and for one or more certificate issuing bodies such as institutes, organizations, authorities and/or regulatory bodies to verify the request and subsequently, issue the requested electronic certificates in accordance with the applicant's request. The invention allows issuance of multiple, distinct electronic certificates across various fields for different purposes, and facilitates effective electronic management of the issued certificates by both the certificate recipients and the issuers. Specifically, the invention enables applicants to conveniently submit certificate requests from an electronic device, such as via a designated application (APP), a website and/or software program accessible by the device. The request preferably comprises the applicant's identification information and the certificate information such as the type, nature and detail of certificate. The electronic submission of the request negates the need for manual paperwork and interactions with different certificate issuing bodies by the applicant. The system will then securely transmit the request to the appropriate certificate issuing bodies, each of which can efficiently process the request by verifying details of the request information and generate the corresponding electronic certificates with the required content in a predetermined format. The present invention further enables multiple certificate issuers from various company sizes, industries, natures and background to register at the system and to operate independently at the respective certificate issuing units of the system. The invention therefore provides a comprehensive solution that streamlines the process of issuing electronic certificate, thereby enhancing the versatility and flexibility of the certificates issued to cater a broad range of certificate issuance requirements. Furthermore, the present invention facilitates storage, access and utility of the issued certificates by the certificate recipients. The certificates are efficiently organized and classified based on their types or categories, allowing for easy access. This improvement enhances the overall effectiveness in managing and maximizing the versatility and utility of electronic certificates.

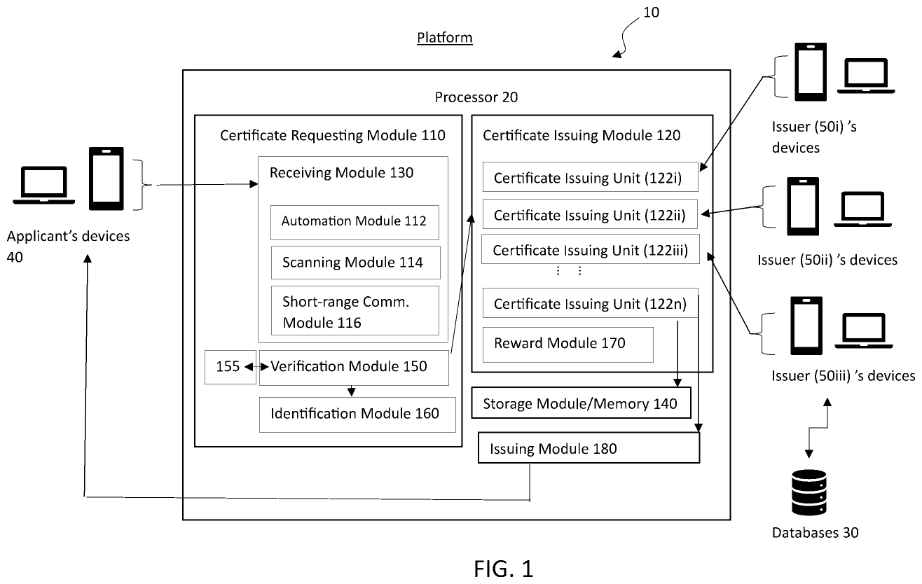

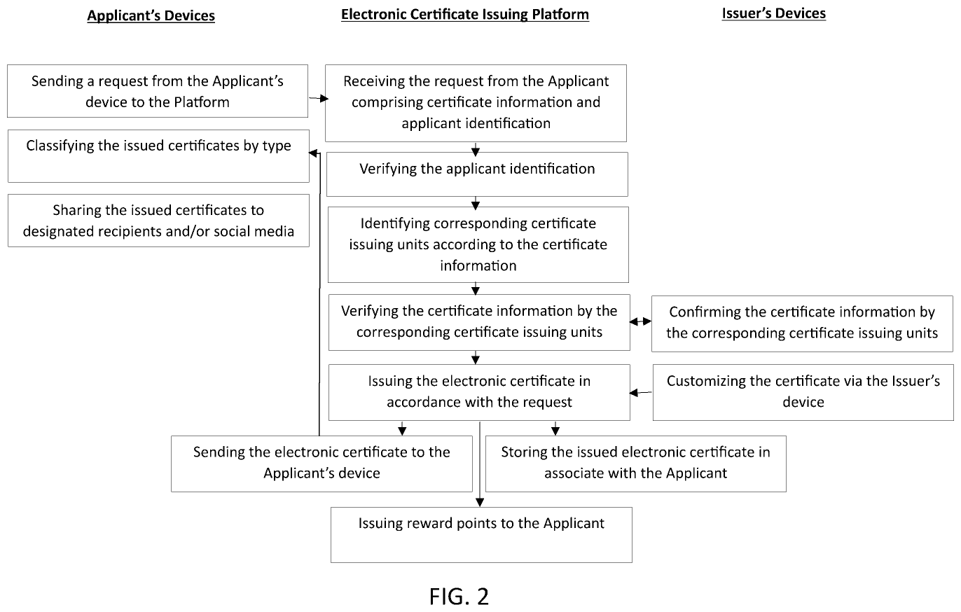

Referring to FIG. 1, shown is a simplified block diagram illustrating a technical implementation of the system 100 according to an embodiment of the present invention. FIG. 2 further shown the embodied steps implemented by the system 100. In this embodiment, the system 100 comprises a computer-implemented platform 10 executed by a processor 20 of a computer device, which can be a local device and/or a remote server, such as a network server or a cloud server. Preferably, the platform 10 is communicable, such as via a communication network, with users' computer devices 40, 50, which can be but are not limited to, one or more desktop computers, laptop computers, tablets, mobile phones or like. The users' computer devices 40, 50 may include, for example, applicant's devices 40 operable by the certificate applicants to submit requests for obtaining electronic certificates; and issuer's devices 50 operable by one or more certificate issuing bodies to process, manage and execute the requests. In one embodiment, the platform 10 can be implemented as a computer program, software, application (APP) and/or provided in the form of a web-based platform operable on the users' computer devices 40, 50. Optionally, the platform 10 can be connected with one or more external servers and/or databases 30 for accessing, retrieving and/or storing information or data, although this is not essential to the implementation of the invention. The communication network may comprise a wireless network, e.g. a wireless cellular network, a wired network, the internet or any combination of the foregoing.

The system 100 comprises a plurality of functional blocks for performing various functions thereof. Preferably, the system 100 comprise a certificate requesting module 110 for processing certificate requests from applicants; and a certificate issuing module 120 for issuing electronic certificates by one or more certificate issuing bodies in accordance with the applicants' requests.

Specifically, the certificate requesting module 110 comprises a receiving module 130 adapted to communicate wirelessly with the applicants' devices 40 to receive requests from applicants for issuing electronic certificates. The request preferably comprises information of the certificate and identification of the applicant, which can be provided in the form of text, image, audio and/or video input. Particularly, certificate information may comprise the required details for processing and issuing the certificate which may include, but are not limited to: name and/or information of the certificate issuing body which can be an institute, an association, an organization, an authority and/or a regulatory body; type of certification, qualification, profession, achievement and/or awards; content of the certification such as the purpose of significance of the certificate; as well as other details or descriptions required by the applicant. The applicant identification may include, for example: personal identification information such as name, age, gender of the like of the applicant; images or photos of the applicant; experience, qualification or credential related to the certification; and/or other information related to the applicant and/or the certification. In one embodiment, the applicant identification may further include hardware characteristic information of the applicant's device 40 representing the applicant's identity. The hardware characteristic information may include, but is not limited to, type of operating system, hardware specification, identification code and/or other hardware related information or the like.

In one embodiment, the certificate request can be inputted manually by the applicant via the applicant's device 40 such as via the keyboard interface of the applicant's device 40. The request may also be input by uploading information from the applicant's device 40 and/or downloading information from other various sources such as from the world wide web, online database or storage means such as based on data stored at the user's social media account, and/or the cloud, etc. The inputting module 112 may optionally comprise an automation module 112 to automatically include the required identification details of applicant as part of the applicant's request, such as after verification of certain biometric data of the applicant, for example, via fingerprint, facial or iris recognition at the applicant's device 40. In another embodiment, the request can be acquired by scanning, such as by a scanning module 114 provided in the form of a scanner or a camera of the applicant's device 40, of a two-dimensional code such as a QR code or a bar code to retrieve the encoded information for the request. For example, the two-dimensional code can be printed, attached or in any way associated with a product, such as a commodity or luxurious items encoding the originality or authenticity information of the products which details can be acquired by scanning of the two-dimensional code using the applicant's device 40. In yet a further embodiment, an applicant's device 40 configured with a short range wireless communication functionality can be used to acquire information for the purpose of the certificate request from one or more corresponding wireless communication-activated devices via short range wireless communication, which can be, but are not limited to, one or more of near-field communication (NFC) Bluetooth, Wi-Fi, NearLink, LPWAAN, and ultra-wideband (UWB), etc. For example, an applicant's device 40 with NFC functionality can be arranged to automatically receive authenticity information from a watch configured with a NFC chip simply by placing the device 40 at a detectable distance from the watch, etc. A person skilled in the art will appreciate that the means for obtaining or acquiring request information from the applicants and/or the applicants' devices should not be limited by the embodiments described. Instead, any other practical means which are known to be applicable to manually, wiredly or wirelessly receive information from the applicants and/or the applicants' devices, as long as they do not depart from the inventive concept of the present invention, shall also be encompassed.

The received request information and particularly, the applicant identification from the request is then verified by a verification module 150 of the certificate request module 110. After the applicant identification is confirmed valid by retrieving and matching with the stored data at the registration database 155, i.e. to verify that the applicant's details have been priorly registered at the system 100 as a valid, registered user, the next step is for the identification module 160 of the certificate requesting module 110 to identify, based on the certificate information of the request, one or more certificate issuing units 122 from a plurality of certificate issuing units (122i, 122ii, 122iii . . . 122n) of the certificate issuing module 120. Each of the plurality of the certificate issuing units (122) is operated independently by the corresponding registered certificate issuing body or issuer. For example, if the applicant's request includes information relating to the issuance of a certificate for awarding a taekwondo black belt to Mr. Jack Smith by ABC Taekwondo School, the verification module 150 will first verify the applicant, Jack Smith, based on the provided personal identification information from the request and the stored data at the registration database 155, as a valid, registered user. After the applicant information is successfully verified, the identification module 160 will identify one or more specific certificate issuing units according to the certificate information from the request, which in this case, the certificate issuing unit 122i which is registered and managed by ABC Taekwondo School. An instruction for issuing an electronic certificate for Jack Smith will then be transmitted in real time to the designated issuer device 50i, which is likely to be operated by the administrative personnel of ABC Taekwondo School. It is important to note that each of the plurality of certificate issuing units 122i to 122n are independently operated and managed by the respective certificate issuers via the corresponding issuers' devices 50i to 50n, and therefore, no exchange of information in relation to the requests as well as the subsequently issued certificates can be shared or in any way accessible among or by the issuers to ensure privacy of the users, and credibility and reliability of the issued certificates.

ABC Taekwondo School, upon notified to receive instruction at the issuer device 50i, will verify the certificate information by retrieving and matching with data from one or more databases 30, which can be, for example, list of details of the black belt awardees for the specified period, etc. The verification may involve verifying identification and qualification of the applicant in relation to the request by matching the details with the school database which can be an external database 30. After a successful verification, the certificate issuing unit 122i will generate an electronic certificate in the name of the applicant, Jack Smith, based on the certificate information in a predetermined format. The issued certificate will be instantly transmitted, via the issuing module 180 of the platform 10, directly to the applicant's device 40. In one embodiment, the certificate can be generated in the form a document file, an image file, a two-dimensional code such as a bar code or a QR code, and/or a document associated with a hyperlink for one to download the electronic certificate, etc. The electronic certificate may further be issued with a two-dimensional code as part of the content of the certificate to facilitate the acquiring of further information relating to the certification, such as information the issuer company or institute, profile or resume of the certificate awardee, and/or other information related to the award or the certificate, for example.

The issued electronic certificate is preferably stored and organized under classification by type of the issued certificate, with the classification being displayable and accessible at the applicant's device 40. For example, the certificates can be organized under the classification of “Sport and Activity”, “Academic”, “Award” and/or “Product”, etc. based on the nature of the certificates, with the classification being customizable by the user to facilitate an effective management and utilization of the electronic certificates. The issued certificates can optionally be shared, via the platform 10 by the applicant device 40 to one or more designated recipients and/or social media networks.

The certificate issuer, via operation at the certificate issuing unit 122, may preferably customize the certificate by selecting a specific design or format of the certificate from a number of existing formats, modifying an existing format, and/or developing a new format based on specific certificate requests or preferences. Other customization, such as but not limited to, to the layout, size, shape, color as well as content of the certificate may further be implemented via the issuers' devices according to the specific requirement of the applicants and/or preferences of the issuer. The customized or new template of certificate can be stored at corresponding the certificate issuing unit 122 for use by the issuer in the future.

The issued certificate in association with the applicant's request, including the certificate information and the applicant identification, will be stored at the respective certificate issuing unit 122, with the stored certificate being accessible by the corresponding issuer device 50. Particularly, different issued certificates can be stored under classification by the information of the certificate and/or the identification of the applicant displayable and accessible at the issuer's devices 50. In one embodiment, all information in relation to the certificate requests and the issued certificates can also be stored at the storage module or memory 140 of the platform 10 for a centralized management by the system administrator.

In one embodiment, the certificate issuing module 120 may further comprise a reward module 170 for issuing reward points to the applicants. The reward points can be provided in the form of one or more credits, loyalty points, cash coupons, vouchers and/or user ratings, tiers or rankings, depending on various conditions applicable to the user or certificate awardee, which may include, for example, the number of certificates awarded, the variety of nature of certificates awarded, and/or the frequency of use of the platform 10, etc. The system 100 further enables the applicant or awardee to share their ratings, tiers or rankings on the social media networks and/or to redeem the reward points in the form of cash coupons or vouchers, etc.

In yet another embodiment, electronic certificates can be requested in relation to a luxurious product by a customer. For example, the product can be a watch, of which the authenticity is required to be verified and certified with the product manufacturer by the customer. To do so, the customer, which is the certificate applicant, may use his/her mobile phone 40 to scan a QR code provide in associate with the watch, or to receive via NFC communication information in relation to the watch by placing his/her mobile 40 at a detectable distance to the watch, assuming the watch is configured with the NFC functionality. Information of the watch will be acquired as the certificate information of the request, along with the consumer's information providing the applicant's identification registered at his/her user account at the platform 10. A request will be received by the receiving module 130. Upon verification of the applicant's identification by the verification module 150, the identification module 160 will identify, from the plurality of certificating issuing units 122i to 122 n of the certificate issuing module 120, certificate issuing unit 122ii for the leather forming the strap of the watch, and certificate issuing unit 122iii for the watch body. Separate request instructions will be sent to the identified certificate issuing units 122ii and 122iii for verification, by the strap manufacturer and the watch manufacturer, based on their product registry or database. Upon confirming details of the requests with the respective certificate issuers, the certificate issuing units 122ii and 122iii will independently issue two electronic certificates or, if requested by the applicant, collaboratively certify the originality and authenticity of the watch, comprising the strap and the watch body, in the form of one certificate. The one or more certificates will be sent directly to the customer's user account accessible at his/her user device 40, and the same can be stored, at the user's preference, under the classification of “product” at his/her user account. The electronic certificate can be forwarded or shared, as a document or a QR code to one or more designated recipients as a proof of authenticity of the watch. If multiple certificates have been awarded to the same customer by the watch manufacturer, the relevant certificate issuing bodies 122 may further issue reward points to the user such as in the form of redeemable loyalty points, product vouchers, cash coupons and/or offering a certain tier or ranking under the brand such as a VIP status, for example. Such reward points will be issued and transmitted by the reward module 170 to the user device 40.

By way of examples, the platform 10 is applicable to issue electronic certificates covering a diverse range of other applications such as, but are not limited to: electronic medical certificates including sick leave certificates or other certificates certifying certain medical conditions of patients issued by medical professionals; educational and training certificates for academic achievements such as diplomas, degrees, course completion certificates, academic transcripts, and certificates of achievement; professional qualification certificates to validate an individual's skills and knowledge such as certifications for IT professionals (e.g., Cisco certifications, Microsoft certifications), project management certifications (e.g., PMP certification), financial certifications (e.g., CPA certification), and various industry-specific certifications; compliance certificates to demonstrate compliance with specific standards, regulations, or industry requirements, such as ISO certifications (e.g., ISO 9001 for quality management systems), GDPR compliance certificates, cybersecurity certifications, and environmental certifications; employment certificates to verify employment details, such as employment history, job positions, and tenure, etc. issued by employers to current or former employees for the purpose of job applications, background checks, and career advancement; financial certificates relating to financial products, transactions, or account statements, such as certificates of deposit, investment certificates, tax certificates, and proof of funds certificates; and legal certificates such as certified electronic copies of birth certificates, marriage certificates, divorce certificates, and death certificates. The platform 10 therefore offers flexibility, accessibility and efficiency in issuing electronic certificates for various applications, enabling integration with various industries, sectors and organizations to facilitate instant verification and issuance of certificates.

In one embodiment, the platform 10 offers a dashboard interface accessible by each certificate issuer operating the respective certificate issuing unit 122. The dashboard interface provides various operation modules to facilitate an effective management of information and data related to the issuance of electronic certificates by the issuer, which may include but are not limited to, the issuer's information setting; pending, accepted and rejected certificate applications or requests; details of the certificate awardees; serial numbers of the issued certificates, library of certificate templates; reward points issued and redeemed; levels of access or permission to administrators; and/or other operation or management modules or functionalities. For example, the dashboard can be used to visualize data, such as in the form of lists or statistics for an effective operation and management to streamline the certificate issuance process.

In another aspect, the present invention further relates to a non-transitory computer readable medium 140 storing machine-readable instructions which, when implemented on a processor 20, implements the steps of the method as described above.

The system and the various modules described above may be implemented at least in part in software. Those skilled in the art will appreciate that the various modules described above may be implemented at least in part using general purpose computer equipment or using bespoke equipment.

Here, aspects of the system and method described herein can be executed on any device or apparatus comprising the system. Program aspects of the technology can be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory storage media, terms such as computer or machine-readable medium refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A computer implemented method of issuing electronic certificates, comprising the step of:
receiving a request from an applicant for an electronic certificate, the request comprising certificate information and applicant identification;
verifying the applicant identification;
identifying one or more relevant certificate issuing units from a plurality of certificate issuing units according to the certificate information; and
upon verifying the certificate information by the one or more relevant certificate issuing units, issuing the electronic certificate in accordance with the request.

2. The computer implemented method of issuing electronic certificates according to claim 1, wherein the step of receiving a request from an applicant comprises receiving information communicated wirelessly from an applicant's device.

3. The computer implemented method of issuing electronic certificates according to claim 2, wherein the step of receiving a request from an applicant comprises scanning of a two-dimensional code by an applicant's device and/or receiving via short range wireless communication by the applicant's device.

4. The computer implemented method of issuing electronic certificates according to claim 3, further comprising the step of transmitting the issued electronic certificate to the applicant's device.

5. The computer implement method of issuing electronic certificates according to claim 1, wherein the step of verifying the certificate information by the one or more relevant certificate issuing units comprises matching data relevant to the certificate information from one or more databases.

6. The computer implemented method of issuing electronic certificates according to claim 1, further comprising the step of storing the issued electronic certificate in associate with the applicant, with the stored electronic certificate being accessible by one or more of an applicant's device and/or an issuer's device.

7. The computer implemented method of issuing electronic certificates according to claim 1, wherein the plurality of certificate issuing units are independently operable by respective certificate issuers via corresponding issuers' devices.

8. The computer implemented method of issuing electronic certificates according to claim 7, further comprising the step of customizing the electronic certificates by the respective certificate issuers.

9. The computer implemented method of issuing electronic certificates according to claim 1, further comprising the step of issuing reward points to the applicant, wherein the reward points are provided in the form of one or more credits, loyalty points, cash coupons, vouchers and/or user ratings, tiers, or rankings.

10. The computer implemented method of issuing electronic certificates according to claim 6, wherein the issued electronic certificate is stored under classification by type of the issued certificate, with the classification being displayable at the applicant's device.

11. The computer implemented method of issuing electronic certificates according to claim 6, wherein the issued electronic certificate is stored under classification by the certificate information and/or the applicant identification, with the classification being displayable at the issuer's device.

12. The computer implemented method of issuing electronic certificates according to claim 1, further comprising the step of sharing the issued electronic certificate to one or more designated recipients and/or social media networks.

13. The computer implemented method of issuing electronic certificates according to claim 1, wherein the step of issuing an electronic certificate comprises generating a two-dimensional code in associate with the certificate.

14. A computer implemented system implementing the steps of claim 1 for issuing electronic certificates, comprising:
a certificate requesting module and a certificate issuing module, the certificate issuing module comprising a plurality of certificate issuing units; wherein
the certificate requesting module comprises:
a receiving module for receiving a request from an applicant for issuing an electronic certificate, the request comprising certificate information and applicant identification;
a verification module for verifying the applicant identification;
an identification module for identifying one or more relevant certificate issuing units from the plurality of certificate issuing units of the certificate issuing module according to the certificate information;
wherein the one or more relevant certificates issuing units, upon verifying the certificate information, is adapted to issue an electronic certificate in accordance with the request.

15. The computer implemented system according to claim 14, wherein the certificate requesting module is adapted to receive the request for issuing an electronic certificate from a user device via wireless communication.

16. The computer implemented system according to claim 14, wherein the certificate requesting module is adapted to receive the request for issuing an electronic certificate via scanning of a two-dimensional code and/or via short-range wireless communication.

17. The computer implemented system according to claim 14, wherein the plurality of certificate issuing units of the certificate issuing module are independently operable by respective certificate issuers via corresponding issuers' devices.

18. The computer implemented system according to claim 14, further comprising a storage module for storing the issued electronic certificate in associate with the applicant.

19. The computer implemented system according to claim 14, further comprising a reward module for issuing reward points to the applicants, wherein the reward points are provided in the form of one or more credits, loyalty points, cash coupons, vouchers and/or user ratings, tiers, or rankings.

20. A non-transitory computer readable medium storing machine-readable instructions which, when implemented on a processor, implements the method of claim 1.
